(19) United States
(12) Patent Application Publication
(10) Pub. No.: US 2025/0138478 A1
(43) Pub. Date: May 1, 2025

(54) HOLOGRAM READING DEVICE AND HOLOGRAM READING METHOD

(71) Applicant: ELECTRONICS AND TELECOMMUNICATIONS RESEARCH INSTITUTE, Daejeon (KR)

(72) Inventors: Yong Hae KIM, Daejeon (KR); Jong-Heon YANG, Daejeon (KR); Kyunghee CHOI, Daejeon (KR); Jae-Eun PI, Daejeon (KR); Chi-Sun HWANG, Daejeon (KR)

(73) Assignee: ELECTRONICS AND TELECOMMUNICATIONS RESEARCH INSTITUTE, Daejeon (KR)

(21) Appl. No.: 18/917,739

(22) Filed: Oct. 16, 2024

(30) Foreign Application Priority Data
Nov. 1, 2023 (KR) 10-2023-0149448

(51) Int. Cl. G03H 1/22

(52) U.S. Cl. CPC G03H 1/2294; G03H 1/2202; G03H 2001/2244

(57) ABSTRACT

Disclosed are a hologram reading device and a hologram reading method, the hologram reading device including a hologram element having a hologram pattern, a detector configured to detect a reflection beam generated in the hologram pattern, and a controller connected to the detector and configured to read information the hologram pattern using a detection signal of the reflection beam, wherein the hologram pattern may have the width or diameter smaller than 225 nm.

### CROSS-REFERENCE TO RELATED APPLICATIONS

This U.S. non-provisional patent application claims priority under 35 U.S.C. § 119 of Korean Patent Application No. 10-2023-0149448, filed on Nov. 1, 2023, the entire contents of which are hereby incorporated by reference.

### BACKGROUND

The present disclosure herein relates to a light reading device and a light reading method, and in particular, to a hologram reading device and a hologram reading method.

Typically, information recorded in hologram is recorded in such a way that actual information is recorded in the Rayleigh-Sommerfeld method, and thus it is difficult to extract the recorded information through physical analysis using SEM, TEM, or the like. Specially, it becomes more difficult to extract information from hologram to be developed to have a high viewing angle according to the evolution of meta-surface technology.

### SUMMARY

The present disclosure provides a hologram reading device and a hologram reading method capable of selectively acquiring necessary information from a hologram image.

An embodiment of the inventive concept provides a hologram reading device including: a hologram element having a hologram pattern; a detector configured to detect a reflection beam generated in the hologram pattern; and a controller connected to the detector and configured to read information of the hologram pattern using a detection signal of the reflection beam, wherein the hologram pattern has the width or diameter smaller than 225 nm.

In an embodiment, the width of the hologram pattern may be greater than 112 nm.

In an embodiment, the hologram reading device may further include a first laser device configured to irradiate the hologram pattern with a first laser beam.

In an embodiment, the hologram reading device may further include a second laser device configured to irradiate a second laser beam having a shorter wavelength than the first laser beam.

In an embodiment, the first laser beam may have the wavelength of 450 nm, and the second laser beam may have the wavelength of 225 nm.

In an embodiment, the hologram reading device may further include a lens between the hologram element and the detector.

In an embodiment of the inventive concept, a hologram reading method includes: irradiating a hologram pattern with a first laser beam of a first wavelength; detecting a reflection beam generated by the first laser beam; determining whether necessary information is present in a hologram image generated by the reflection beam; and acquiring the necessary information by irradiating the hologram pattern with a second laser beam having a second wavelength shorter than the first wavelength when the necessary information is not present in the hologram image.

In an embodiment, the hologram pattern may have a width smaller than 225 nm.

In an embodiment, the width of the hologram pattern may be greater than 112 nm.

In an embodiment, the first laser beam may have a wavelength of 450 nm, and the second laser beam may have a wavelength of 225 nm.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is an example hologram reading device according to the present inventive concept;

FIG. 2 is a cross-sectional view showing an example of a hologram element of FIG. 1;

FIG. 3 is a simulation result of Equation (1) according to pixel pitch;

FIG. 4 is an image showing necessary information in a hologram image; and

FIG. 5 is a flowchart showing an example optical alignment method according to the present inventive concept.

### DETAILED DESCRIPTION

Hereinafter, exemplary embodiments of the present disclosure will be described in conjunction with the accompanying drawings. The above and other aspects, features, and advantages of the present disclosure will become apparent from the detailed description of the following embodiments in conjunction with the accompanying drawings. However, it should be understood that the present invention is not limited to the following embodiments and may be embodied in different ways. Rather, the embodiments are provided so that so that this disclosure will be thorough and complete and will fully convey the concept of the invention to those skilled in the art, and the present disclosure will only be defined by the appended claims. Throughout this specification, like numerals refer to like elements.

The terminology used herein is for the purpose of describing particular embodiments only and is not intended to limit the scope of the present disclosure. As used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof. Also, as just exemplary embodiments, reference numerals shown according to an order of description are not limited to the order.

Moreover, exemplary embodiments will be described herein with reference to cross-sectional views and/or plane views that are idealized exemplary illustrations. In the drawings, the thickness of layers and regions are exaggerated for effective description of the technical details. Accordingly, variations from the shapes of the illustrations as a result, for example, of manufacturing techniques and/or tolerances, are to be expected. Thus, exemplary embodiments should not be construed as limited to specific shapes illustrated herein but are to include deviations in shapes that result from manufacturing.

Hereinafter, the present invention will be explained in detail with reference to the accompanying drawings.

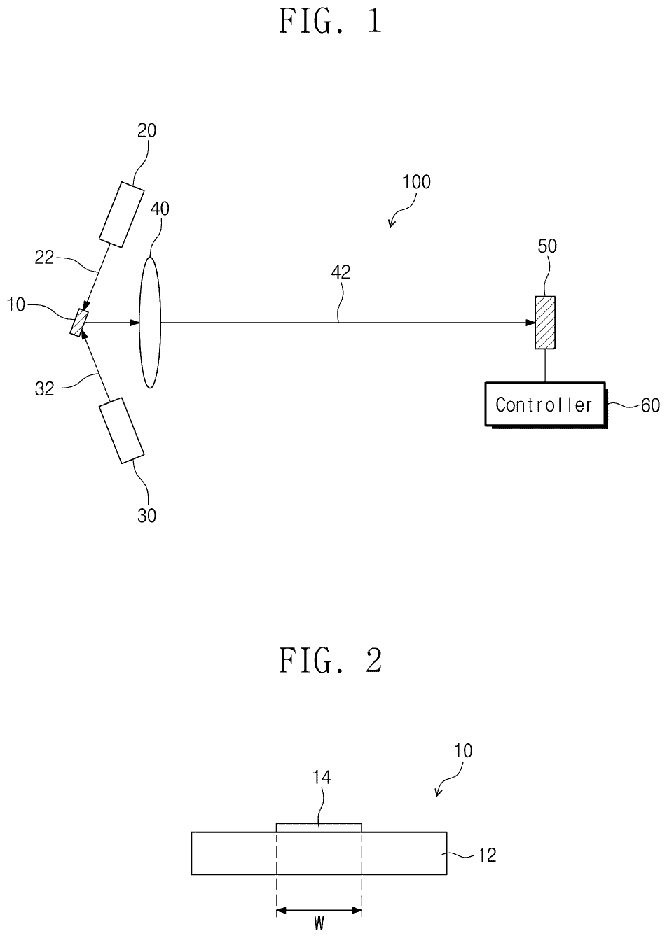

FIG. 1 shows an example hologram reading device 100 according to the inventive concept. FIG. 2 shows an example of a hologram element 10 of FIG. 1.

Referring to FIG. 1, the hologram reading device 100 may include a hologram element 10, a first laser device 20, a second laser device 30, a lens 40, a detector 50, and a controller 60.

The hologram element 10 may receive a first laser beam 22 of the first laser device 20 and a second laser beam 32 of the second laser device 30 to generate a reflection beam 42. The reflection beam 42 may generate a hologram image.

Referring to FIG. 2, the hologram element 10 may include a substrate 12 and a hologram pattern 14 on the substrate 12. The hologram pattern 14 may have the width W or diameter greater than about 112 nm and not greater than about 225 nm. Referring to FIGS. 1 and 2, the first laser device 20 may provide the first laser beam 22 to the hologram pattern 14 of the hologram element 10. The first laser beam 22 may have a first wavelength of about 450 nm. The hologram pattern 14 may not display necessary information or encrypted information through the first laser beam 22. For example, the hologram pattern 12 may provide the reflection beam 42 of the hologram image to the lens 40 and the detector 50 at a viewing angle of at least about 180°. The hologram image of the viewing angle of at least about 180° may have the necessary information encrypted therein.

The second laser device 30 may have a second wavelength shorter than the first wavelength of the first laser beam 22. The second wavelength of the second laser beam may be half the first wavelength. For example, the second wavelength may be about 225 nm. The second laser beam 32 may generate the reflection beam 42 having the necessary information in the hologram image.

The lens 40 may be provided on the hologram element 10. The lens 40 may project the reflection beam 42 onto the detector 50. The lens 40 may include a convex lens.

The detector 50 may be provided adjacent to the lens 40. The detector 50 may receive the reflection beam 42 to acquire a detection signal. The detector 50 may include a charge-coupled device CCD or a CMOS image sensor.

The controller 60 may be connected to the detector 50. The controller 60 may use the detection signal from the detector 50 to acquire the hologram image. The controller 60 may determine whether the necessary information is present in the hologram image. Although not shown, the controller 60 may be connected to the first laser device 20 and the second laser device 30. When the necessary information is not present in the hologram image generated by the first laser device 20, the second laser device 30 may irradiate the hologram pattern 14 with the second laser beam 32. The second laser beam 32 may display the necessary information in the hologram image having the viewing angle of at least about 180° by the reflection beam 42. The controller 60 may provide the necessary information to a worker or a user.

Accordingly, the hologram reading device 100 may provide, to the hologram pattern 14, the second laser beam 32 of the second wavelength shorter than the first wavelength of the first laser beam 22, and selectively acquire the necessary information from the hologram image.

Meanwhile, a computer-generated holography (CGH) method for calculating hologram of a high viewing angle may be described with the following Equation (1) of the Rayleigh-Sommerfeld equation.

$$\text{?} \qquad ( 1 )$$

$$\text{?} \text{indicates text missing or illegible when filed}$$

In a typical case, the orthogonal coordinate system is used as an image coordinate system. However, in case of having a high viewing angle, the size of coordinate plane may become very large. Accordingly, it is preferable to solve Equation (1) using the orthogonal coordinate system as the spatial light modulator (SLM) coordinate system and a spherical coordinate system as the image coordinate system. Here, when a sample interval (dx, dy) is kept constant in the image coordinate system, a fast Fourier system (FFT) may be used. However, as the viewing angle becomes high, the interval of the reproduced image is severely distorted. Thus, in case of a high view angle, the method is not recommended. In a more typical image coordinate system, Equation (1) is required to be calculated with a non-uniform fast Fourier transform (NUFFT). In case of adopting the NUFFT, Equation (1) may be simply expressed as Equation (2).

$$E ( p , q , r ) = F ( p , q , r ) {Nufft}_{1} ( SLM ( m , n ) M ( m , n , r ) ) \qquad ( 2 )$$

E(p, q, r) represents the size of field in the actual image coordinate system. Nuffnₜ₁ denotes a first type NUFFT, and F(p, q, r) denotes a proportional constant. Furthermore, SLM(m, n) is a term for adjusting the SLM using a meta-surface, and M(m, n, r) is a focusing term. Equation (2) may be simply expressed as the following Equation (3).

$${E}_{r} = {P}_{slm}^{r} {E}_{slm} \qquad ( 3 )$$

Inversely, in case of knowing E(p, q, r) is known, the field on an SLM plane may be known as the following equation (4).

$${SLM}_{0} ( m , n ) M ( m , n , {r}_{0} ) = F ( p , q , {r}_{0} ) {Nufft}_{2} ( {EF}_{0} ( p , q {r}_{0} ) )$$

where Nuffₜ₂ denotes a second type NUFFT. Equation (4) may be simply expressed as the following Equation (5).

$${E}_{slm} = {P}_{r}^{slm} {E}_{r} \qquad ( 5 )$$

In case where there are (N+1) images, the images are first sorted by distance and then SLM patterns are calculated from an image having the longest distance. Here, Equation (5) may be expressed as Equation (6) in consideration that an image is masked by the next image.

$${E}_{N}^{total} = {E}_{N} + {M}_{N} {P}_{N - 1}^{N} {E}_{N - 1}^{total} \qquad ( 6 )$$

where E_{N}^{total} denotes the total electric field on a spherical surface of an N-th image, E_{N} denotes the electric field in an N-th image, M_{N}P_{N-1}^{N}E_{N-1}^{total} may express that the total electric field on a spherical surface of an (N-1)-th image propagates to arrive on the spherical surface of the N-th image and is occluded by the N-th image.

For convenience of calculation, when the masking work is changed to an aperture work, Equation (6) may be expressed as the following Equation (7).

$$\text{?} \qquad ( 7 )$$

$$\text{?} \text{indicates text missing or illegible when filed}$$

Accordingly, the SLM image may be expressed as the following Equation (8).

$${E}_{slm} = {P}_{N}^{slm} {E}_{N}^{total} = {P}_{N}^{slm} ( {P}_{N - 1}^{N} {E}_{N - 1}^{total} + Δ {E}_{N} ) = {P}_{N - 1}^{slm} {E}_{N - 1}^{total} + {P}_{N}^{slm} Δ E \text{?} \qquad ( 8 )$$

$${E}_{slm} = {P}_{0}^{slm} {E}_{0} + {P}_{1}^{slm} Δ {E}_{1} + {P}_{2}^{slm} Δ {E}_{2} + … {P}_{N}^{slm} Δ {E}_{N}$$

$$\text{?} \text{indicates text missing or illegible when filed}$$

Namely, the SLM pattern of a 0-th image is first calculated, and then the SLM patterns are all added together using the difference between the electric field in the N-th image and the propagated electric field from the (N−1)-th image to the N-th image. The entire image calculation process on the spherical surfaces of the first and second images may be expressed as the following Equation (9).

$${P}_{1}^{slm} Δ {E}_{1} = {P}_{1}^{slm} ( {E}_{1} - {A}_{1} {P}_{0}^{1} {E}_{0}^{total} ) = {P}_{1}^{slm} ( {E}_{1} - {A}_{1} {P}_{slm}^{1} {P}_{0}^{slm} {E}_{0} ) \qquad ( 9 )$$

$${P}_{1}^{slm} {E}_{1}^{total} = {P}_{1}^{slm} {E}_{0}^{total} + {P}_{1}^{slm} Δ {E}_{1} = {P}_{0}^{slm} {E}_{0} + {P}_{1}^{slm} Δ {E}_{1}$$

$${P}_{2}^{slm} Δ {E}_{2} = {P}_{2}^{slm} ( {E}_{2} - {A}_{2} {P}_{1}^{2} {E}_{1}^{total} ) = {P}_{2}^{slm} ( {E}_{2} - {A}_{2} {P}_{slm}^{2} {P}_{1}^{slm} {E}_{1}^{total} )$$

$${P}_{2}^{slm} {E}_{2}^{total} = {P}_{2}^{slm} {P}_{1}^{2} {E}_{1}^{total} + {P}_{2}^{slm} Δ {E}_{2} = {P}_{1}^{slm} {E}_{1}^{total} + {P}_{2}^{slm} Δ {E}_{2}$$

Holograms for images of multiple layers may be calculated using Equation (9), and thus mesh hologram for a mesh structure may be calculated.

The feature of a hologram image of a high viewing angle may be explained as the following Equation (10) through such hologram calculation.

$${θ}_{VA} = 2 {sin}^{- 1} ( \frac{λ}{2 p} ) \qquad ( 10 )$$

where θ_{VA} denotes a viewing angle of the hologram image, p denotes a pixel pitch, and λ denotes the wavelength of the first laser beam 22 or the second laser beam 32. Typically, since a pixel pitch is greater than the wavelength, the viewing angle becomes small. For example, the viewing angle of a hologram with the pixel pitch of 1 μm is about 30 degrees. However, the pixel pitch of a hologram using a meta element may be smaller than the wavelength. When the pixel pitch is half the wavelength, the viewing angle is 180 degrees, but when the pixel pitch is smaller than the half of the wavelength, the viewing angle may not be obtained by Equation (10).

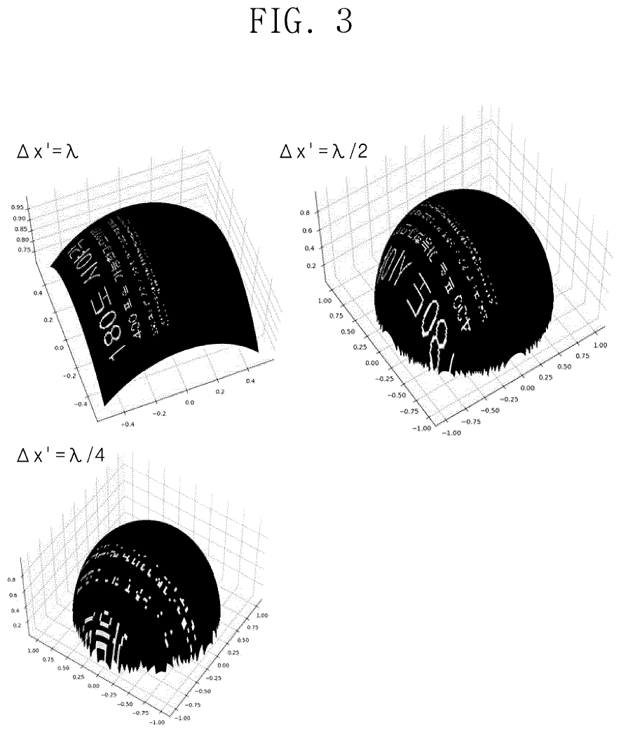

FIG. 3 is a simulation result of Equation 1 according to the pixel pitch.

Referring to FIG. 3, it may be understood that when the pixel pitch is equal to the wavelength, all information is shown within the viewing angle, but when the pixel pitch is half the wavelength, the viewing angle is 180 degrees and a portion of information disappears. Especially, it may be understood that when the pixel pitch is quarter the wavelength, a large amount of information disappears.

Therefore, a hologram encryption system may be constructed using the above-described relationship. Necessary information in an hologram image is typically observed under visible light, and thus the information may be recorded through the hologram pattern 14 having a very small width W compared to the first wavelength of about 450 nm that is the minimum wavelength of the visible light. When the first wavelength of the first laser beam 22 is about 450 nm, the hologram pattern 14 with the width W of about 450 nm/2 to about 450 nm/4 has the viewing angle over 180° and may not display information thereabout. The width W of the hologram pattern 14 may be about 112 nm to about 225 nm. When the second wavelength of the second laser beam 32 is about 225 nm, the hologram pattern 14 with the width W of about 112 nm to about 225 nm may display the necessary information thereabout. The width W of the hologram pattern 14 may be the pixel pitch or the diameter, and is not limited thereto.

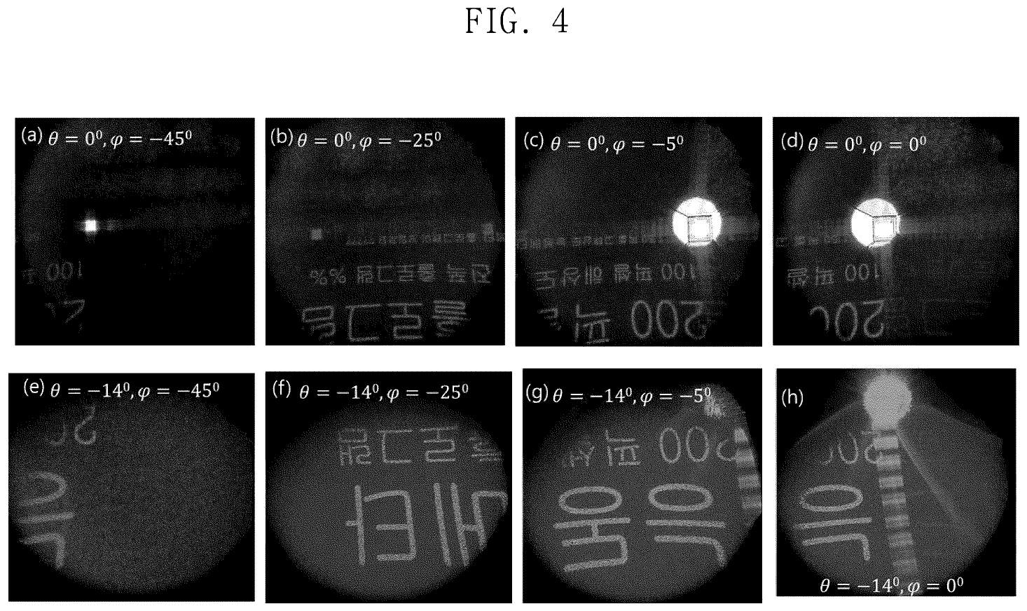

FIG. 4 shows the necessary information in the hologram image.

Referring to FIG. 4, the second laser beam 32 may be provided to represent the necessary information about an active meta-hologram in the hologram image.

A hologram reading method of the hologram reading device 100 configured as the above-described will be described below.

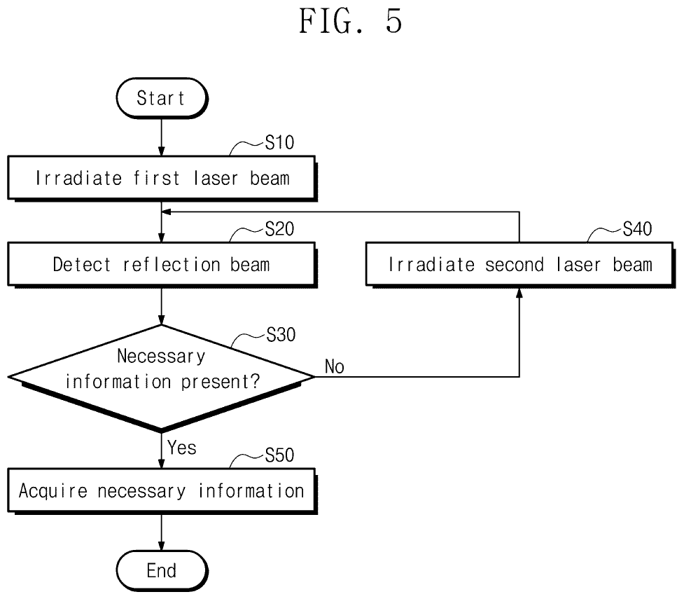

FIG. 5 shows an example optical alignment method according to the present inventive concept.

Referring to FIGS. 1 and 5, the first laser device 20 may irradiate the hologram pattern 14 of the hologram element 10 with the first laser beam 22 (step S10). The first wavelength may be about 450 nm. The first laser beam 22 may be reflected by the hologram pattern 12 to generate the reflection beam 42. The reflection beam 42 may be transmitted through the lens 40 to be provided to the detector 50. The hologram pattern 14 may have the width W of about 112 nm to about 225 nm. Then, the detector 50 detects the reflection beam 42 to acquire the hologram image (step S20).

The controller 60 may determine whether the necessary information is present in the hologram image (step S30). The necessary information may be data stored in advance in a database. Unlike this, the necessary information may be defined by a worker or a user, and is not limited thereto.

When the necessary information is not present in the hologram image, the second laser device 30 provides the second laser beam 32 with the second wavelength to the hologram pattern (step S40). The second wavelength may be shorter than the first wavelength.

The detector 50 detects the reflection beam 42 (step S20), and the controller 60 may determine again whether the necessary information is present in the hologram image.

When the necessary information is present in the hologram image, the controller 60 acquires and stores the necessary information (step S50).

As described above, the hologram reading device may provide, to a hologram pattern, the second laser beam of the second wavelength shorter than the first wavelength of the first laser beam and selectively acquire the necessary information from the hologram image.

The exemplary embodiments of the present disclosure have been described above with reference to the accompanying drawings, but those skilled in the art will understand that the present disclosure may be implemented in another concrete form without changing the technical spirit or an essential feature thereof. Therefore, the aforementioned exemplary embodiments are all illustrative and are not restricted to a limited form.

What is claimed is:

1. A hologram reading device comprising:
a hologram element having a hologram pattern;
a detector configured to detect a reflection beam generated in the hologram pattern; and
a controller connected to the detector and configured to read information of the hologram pattern using a detection signal of the reflection beam,
wherein the hologram pattern has a width or diameter smaller than 225 nm.

2. The hologram reading device of claim 1, wherein a width of the hologram pattern is greater than 112 nm.

3. The hologram reading device of claim 1, further comprising a first laser device configured to irradiate the hologram pattern with a first laser beam.

4. The hologram reading device of claim 3, further comprising a second laser device configured to irradiate a second laser beam having a shorter wavelength than the first laser beam.

5. The hologram reading device of claim 4, wherein
the first laser beam has a wavelength of 450 nm, and
the second laser beam has a wavelength of 225 nm.

6. The hologram reading device of claim 1, further comprising:
a lens between the hologram element and the detector.

7. A hologram reading method comprising:
irradiating a hologram pattern with a first laser beam of a first wavelength;
detecting a reflection beam generated by the first laser beam;
determining whether necessary information is present in a hologram image generated by the reflection beam; and
acquiring the necessary information by irradiating the hologram pattern with a second laser beam having a second wavelength shorter than the first wavelength when the necessary information is not present in the hologram image.

8. The hologram reading device of claim 7, wherein the hologram pattern has a width smaller than 225 nm.

9. The hologram reading device of claim 8, wherein the width of the hologram pattern is greater than 112 nm.

10. The hologram reading device of claim 9, wherein
the first laser beam has a wavelength of 450 nm, and
the second laser beam has a wavelength of 225 nm.
